(19) United States
(12) Patent Application Publication
(10) Pub. No.: US 2026/0126968 A1
(43) Pub. Date: May 7, 2026

(54) REUSING PROGRAMMING ENVIRONMENTS IN A DISTRIBUTED COMPUTING ENVIRONMENT

(71) Applicant: Palantir Technologies Inc., Denver, CO (US)

(72) Inventors: João CORREIA, London (GB); Jonathan LAFLECHE, London (GB); Willi RASCHKOWSKI, London (GB); John AYAD, London (GB)

(21) Appl. No.: 18/981,398

(22) Filed: Dec. 13, 2024

Related U.S. Application Data
(60) Provisional application No. 63/716,697, filed on Nov. 5, 2024.

(51) Int. Cl. G06F 8/36; G06F 8/71

(52) U.S. Cl. CPC G06F 8/36; G06F 8/71

(57) ABSTRACT

A system and related methods for creating a new programming environment from existing programming environments is disclosed. The system is programmed to retrieve relocatable packages of existing programming environments for a programming language from a remote repository and locally set up the existing programming environments as components of a new programming environment for the programming language. The system is programmed to further adjust an environment variable for the programming language based on priorities associated with the existing programming environments. The setup can utilize symbolic links to encapsulate library version information and encourage reuse of the directory structure of the local programming environment represented by the symbolic links when any component of the new programming environment has an update available.

This application claims the benefit under 35 U.S. C. § 119(e) of U.S. Provisional Application No. 63/716,697, titled “REUSING PROGRAMMING ENVIRONMENTS IN A DISTRIBUTED COMPUTING ENVIRONMENT” and filed on Nov. 5, 2024, the entire contents of which are hereby incorporated by reference as if fully set forth herein.

### TECHNICAL FIELD

The present disclosure relates to programming environment management, and more particularly to reusing previously-built programming environments in a distributed computing environment.

### BACKGROUND

In a distributed computing environment, different devices could contribute code of multiple versions to a repository, which is accessible to other devices. The code can be written in one or more programming languages. Conventionally, building a new programming environment for a specific programming language, such as Python, could involve identifying and retrieving all relevant files and libraries from the repository across a computer network, setting up these files and libraries on a local host, and updating one or more relevant environment variables associated with the specific programming language to reflect the setup. Such a process could take time and delay project development. There exist programming environment managers that facilitate porting programming environments. However, it still takes a relatively long time for such a programming environment manager to create a new programming environment on a specific device in the distributed computing environment. It would be helpful to have an improved mechanism that expedites the creation of a programming environment for active project development and deployment.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced;

FIG. 2A illustrates aspects of example programming environments.

FIG. 2B illustrates aspects of an example combined programming environment.

FIG. 3 illustrates a process of creating a new programming environment from existing programming environments in accordance with disclosed embodiments.

FIG. 4 illustrates an example computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. General Overview

A system and related methods for creating a new programming environment from existing programming environments is disclosed. The system is programmed to retrieve relocatable packages of existing programming environments for a programming language from a remote repository and locally set up the existing programming environments as components of a new programming environment for the programming language. The system is programmed to further adjust an environment variable for the programming language based on priorities associated with the existing programming environments. The setup can utilize symbolic links to encapsulate library version information and encourage reuse of the directory structure of the local programming environment represented by the symbolic links when any component of the new programming environment has an update available.

In some embodiments, different devices in a distributed computing environment can be configured to manage respective local programming environments for a specific programming language, such as Python. For example, a first type of programming environment can be for building organizational libraries that provide organizational features associated with an organizational account, a second type of programming environment can be for building user libraries that work with user code associated with a specific user account managed by the organizational account, and a third type of programming environment can be for developing the user code. While developing the user code generally depends on the organizational and user libraries from the first type of programming environment and the second type of programming environment, those libraries could generally be developed independently.

In some embodiments, the user code associated with the specific user account could be developed, tested, or deployed on any user device generally for individual use or any computing device as part of a cluster managed by a server in the distributed computing environment. For such development, testing, or deployment, the chosen device would establish the third type of programming environment.

In some embodiment, to facilitate establishing a new programming environment as the third type of programming environment on another device, each type of programming environment could be saved as a relocatable package and later relocated to another device. The relocatable package can include everything in the programming environment. Alternatively, the relocatable package could include just the specific portion being built or developed, such as the user code, given that the other portions could be replaced in the new programming environment. The replacement can be helpful, for example, when the specific user account continues to develop user code in the same programming environment even while the organizational libraries and user libraries continue to be updated in newer first type of programming environments and second type of programming environments.

In some embodiments, to establish a new programming environment as the third type of programming environment, a device is programmed to retrieve relocatable packages that correspond to different portions of the third type of programming environment. For example, the relocatable packages could correspond to the three types of programming environments. For Python, for example, a programming environment management tool can be used to create a relocatable package of a programming environment and recreate the programming environment from the relocatable package. Each programming environment generally corresponds to a folder of files and libraries. Therefore, creating a relocatable package can involve compressing the folder, while recreating the programming environment can involve uncompressing the folder and fixing pathnames. In each folder, there could be one or more groups of libraries, which typically correspond to sub-folders of specific names, or there could be user code. For example, the one or more groups of libraries can include a first group of core libraries for the specific programming language, a second group of dynamically loaded libraries, and a third group of third-party extension libraries.

In some embodiments, the device is programmed to set up symbolic links to version-specific pathnames each folder, where the link names of the symbolic links contain version-agnostic symbols. In order for the new programming environment to work, an environment variable can be set that tells an interpreter (or a compiler) of the specific programming language where to find the necessary libraries. Some interpreters require the environment variable to have a known value at start time. Having the environment variable set to fixed pathnames eliminates the need to obtain he pathnames of the sub-folders for these version-specific libraries at startup time. Moreover, the link names of these symbolic links can be added to the environment variable once without requiring updates as any portion of the new programming environment receives an update. This can reduce the chance of error in the operation of the interpreter when the new programming environment continues to be updated one portion at a time while reusing the corresponding directory structure represented by the symbolic links.

In some embodiments, different portions of the new programming environment can be updated at different frequencies. For example, the organizational libraries might change more often than the user libraries from external sources, but not as often the user code. Therefore, the device does not need to retrieve relocatable packages of programming environments containing all dependent libraries each time. On the other hand, different portions of the new programming environment tend to be associated with different priorities. When different versions of certain libraries are present in different portions of the new programming environment, the interpreter would want to locate the best version first and stop the search, which means that link names of the symbolic links are to be added to the environment variable in an order based on the priorities.

The system disclosed herein has several technical benefits. By retrieving relocatable packages of programming environments instead of individual files and libraries from the programming environments, the system reduces the amount of time recreating the programming environments and thus the delay in coding project development. By allowing different portions of a programming environment to be developed and preserved separately before ultimately being combined, the system further reduces the amount of time recreating the programming environments by only retrieving the corresponding relocatable package as needed. By utilizing symbolic links, the system simplifies maintenance of environment settings for a new programming environment. The ability to create the new programming environment by reusing existing programming environments fundamentally allows a coding project to quickly progress on any appropriate device in a distributed computing environment, improving the utilization of resources in the distributed computing environment.

### 2. Example Computing Environments

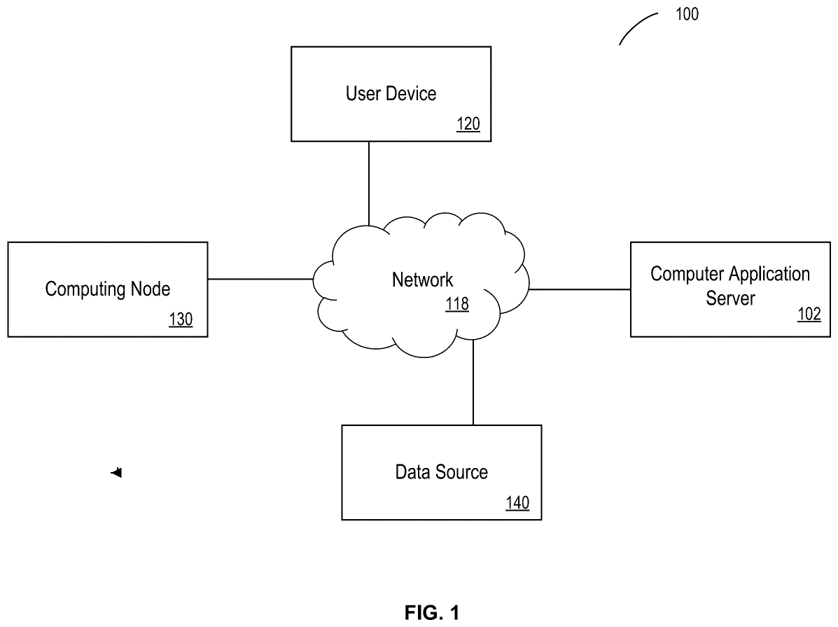

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer application server (“server”) 102, a user device 120 or more user devices, a computing node 130 or more computing nodes, and a data source 140, which are communicatively coupled through direct physical connections or via a network 118.

In some embodiments, the user device 120 is programmed or configured to manage project development in one or more programming languages for one or more user accounts. The management can include building or maintaining local programming environments or accessing a remote repository to retrieve or submit relocatable packages of programming environments. The user device 120 can be programmed to further receive code in the one or more programming languages or enable review, update, or execution of the code stored in a local memory or in the remote repository. The user device 120 node can comprise a personal computing device, such as s desktop computer, laptop computer, tablet computer, smartphone, or wearable device.

In some embodiments, the computing node 130 is programmed or configured to manage local storage and run one or more threads to perform various tasks by executing computer applications. The tasks can include read or write transactions on data saved in the local storage or a central storage managed by the server 102. The computing node 130 is also programmed to communicate with the server 102 to help perform tasks that require cooperation of computing nodes, which can include accessing external storage associated with another computing node with appropriate permission. Specifically, the computing node 130 can be programmed or configured to manage project deployment in one or more programming languages for one or more user accounts. The management can similarly include building or maintaining local programming environments or accessing a remote repository to retrieve or submit relocatable packages of programming environments. The computing node 130 can comprise similar computing facility as the server 102, as further discussed below. The computing node 130 can also comprise a personal computing device, such as s desktop computer, laptop computer, tablet computer, smartphone, or wearable device.

In some embodiments, the data source 140 is programmed or configured to manage releases of a programming language or updates thereto. Each release can include a specific version of one or more groups of libraries for the programming language. For example, the data source 140 can be an official Python server. The data source 140 can comprise any computing facility with sufficient computing power in data processing, data storage, and network communication for performing the above-mentioned functions.

In some embodiments, the server 102 is programmed or configured to manage a distributed computing environment comprising the computing node 130 or other computing nodes. The server 102 can be programmed to coordinate with the computing nodes to execute jobs or handle data in a distributed manner. The server 102 can be programmed to also manage an ontology of object and links and a repository that supports the ontology and can be implemented as a standalone storage device or by a combination of local storage devices associated with the computing nodes. In addition, the server 102 can be programmed to receive releases of the programming language from the data source 140 and store at least the latest release in the repository. The server 102 can also be programmed to provide additional updates related to the programming language, such as code modules in the programming language that reflect updates to the ontology or other aspects of the distributed computing environment. The server 102 can comprise any centralized or distributed computing facility with sufficient computing power in data processing, data storage, and network communication for performing the above-mentioned functions.

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, a first user device is configured to offer a programming environment and receive updated code developed in the programming environment and associated with a user account. The first user device is programmed to then create a relocatable package of the programming environment and transmit the relocatable package to the repository. The server 102 can be programmed to store the relocatable package and generate metadata for the relocatable package based on the organization and management structure of the repository.

In some embodiments, the server 102 is programmed to receive updates regarding a specific programming language from the data source 140 or an organization account associated with the server 102. The server 102 can be programmed to store these updates as one or more relocatable packages of specific programming environments in the repository. The user device 120 is configured to establish a first new programming environment for the specific programming language to develop or test code modules in the specific programming language.

Instead of building the first new programming environment from scratch, the user device 120 can be configured to retrieve, from the repository, one or more relocatable packages of programming environments and combine these programming environments into the first new programming environment. The user device 120 can be configured to subsequently receive a request to officially launch a computer program corresponding to the code modules. The user device 120 can be configured to transmit the computer program to the repository and together with a request to execute the computer program in the distributed computing environment. The server 102 can be configured to then generate a job of one or more tasks for executing the computer program and transmit a task to the computing node 130. The computing node 130 can be programmed to then establish a second new programming environment for the specific programming language similar to the way the user device 120 was configured to establish the first new programming environment.

### 3. Functional Descriptions

### 3.1. Preserving Programming Environments

In some embodiments, the server 102 is programmed to manage a distributed computing environment including computing nodes or user devices. Specifically, the server 102 is programmed to manage a repository hosted by one or more computing nodes or other devices in the distributed computing environment. The server 102 can also be programmed to manage an ontology of objects and links with access control mechanisms, which are supported by the repository, for example. In addition, the server 102 can be programmed to manage installations of one or more programming languages, which can be used to transform data in the repository or perform other tasks. The installations can include updates to one or more groups of libraries associated with such a programming language. The server 102 can also be programmed to store such updates in the repository. For example, they can be integrated into specific programming environments and then saved as relocatable packages of the specific programming environments.

In some embodiments, a user device 120 is programmed to transmit code developed by a user account to the repository. The code can be private to the user account or user device 120 or accessible to other user accounts or devices in the distributed computing environment under specific access control mechanisms implemented by the repository. The user device 120 is thus also programmed to retrieve code from the repository, which can constitute dependencies for the code being developed by the user account.

In some embodiments, the user device 120 is programmed to submit a request to the server 102 for executing specific code modules in the distributed computing environment. The server 102 is programmed to then distribute a corresponding job for executing the specific code modules to the computing nodes. The user device 120 can also be programmed to directly execute specific code modules in the local environment.

In some embodiments, the server 102, a computing node 130, or a user device 120 is programmed to support the development and execution of code modules in specific programming languages. One such programming language is Python. A programming environment established by an operating system on a device, such as a Python environment, can comprise a large number of files that are related through dependencies. The server 102 can be programmed to maintain a policy document that identifies specific packages each having a set of related files from the programming environment. Such a policy document can be used to divide a potentially large programming environment into separate modules for easier processing or transmission. An example policy document can identify a package that includes files or libraries that are managed by an organization account associated with the server 102, such as one configured to maintain the ontology architecture, and generally shared across all devices in the distributed computing environment. This package can include files or libraries specific to the programming language or the organizational account. The example policy document can identify additional packages that include files associated with a user account or user group. Such a package can include code or any dependencies specific to the user account or user group.

In some embodiments, a user device 120 is programmed to create or otherwise obtain a relocatable package from a local programming environment according to the policy document using existing tools. For example, the Conda platform includes a conda-pack tool that can be used to generate a compressed archive of a programming environment. Other examples include the Pip tool or the Poetry tool. The user device 120 is programmed to then transmit the resulting package instead of individual files to the repository, which is saved in the repository and can be retrieved by another device and thus relocated to that device. Alternatively, the user device 120 can be programmed to transmit individual files to the server 102 or the repository, while the server 102 can be programmed to then generate relocatable packages before or after saving relevant files to the repository or only save the relocatable packages. The server 102 or a computing node 130 can be programmed to similarly create or otherwise obtain a relocatable package from a local programming environment according to the policy document using existing tools.

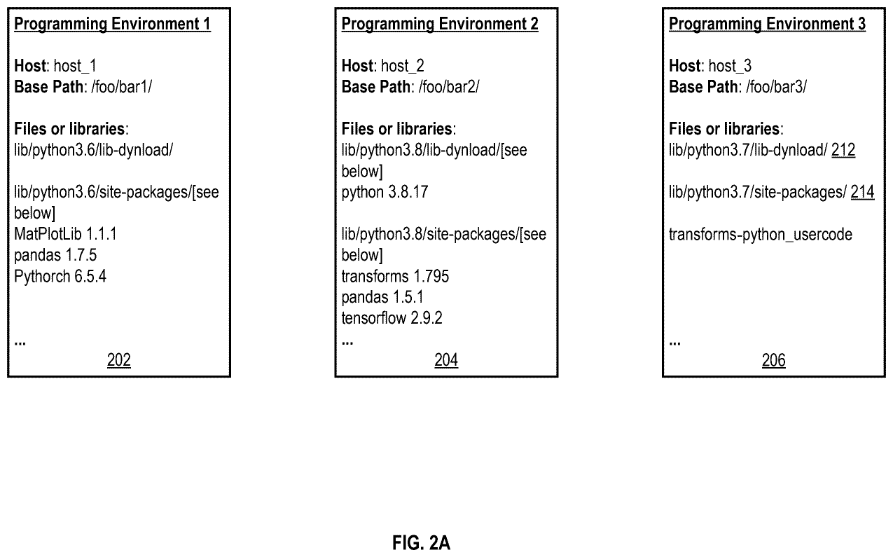

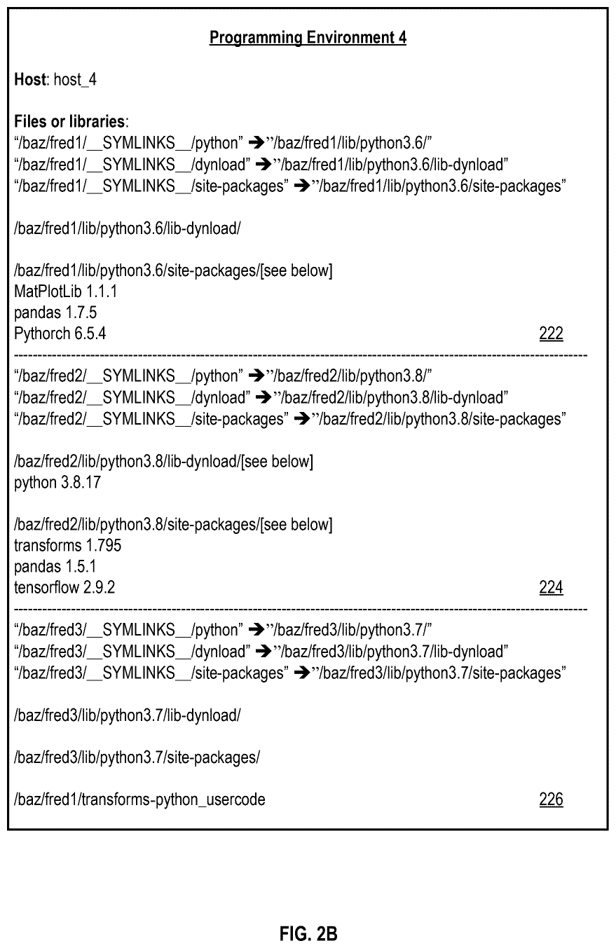

FIG. 2A illustrates aspects of example programming environments. Each programming environment is currently associated with a particular path on a user device, where the corresponding files or libraries can be found. Each programming environment has a known project structure typically with a corresponding directory structure, such as a folder 212 for core libraries for the programming language and a folder 214 for additional libraries in the third programming environment 206. In this example, each of the directory structures includes “dynload” (for dynamically loaded modules) and “site-packages” (third-party packages) as sub-folders under the main Python library folder.

In this example, the first programming environment 202 is used to develop or maintain code generally used by an organizational account associated with the server 102. It includes the open source library Pandas in a first version (1.7.5). The second programming environment 204 is used to develop or maintain dependencies of code associated with a user account. In includes Pandas in a second version (1.5.1), which can include user-specific modification. The third programming environment 206 is used to develop or maintain code specific to a user account. It is understood that this is just an illustration. The second programming environment and the third programming environment can coincide for some user accounts or user groups, for example.

### 3.2. Combining Programming Environments

In some embodiments, to establish a new programming environment, a device, which can be the server 102, a computing node 130, or a user device 120, is programmed to retrieve several saved packages from the repository identified in the policy document, to ultimately combine the programming environments corresponding to the saved packages into the new programming environment. For each saved package, the device can be programmed to establish a folder (directory) of files and libraries for the programming environment corresponding to the saved package, directly as a result of the retrieval or by decompressing any saved package that exists in a compressed form. To further restore the programming environment, the device can be programmed to make adjustments necessary for the relocation. For example, the Conda platform includes a conda-unpack tool that can be used to replace pathname prefixes or make other adjustments.

In some embodiments, the device is programmed to create symbolic links to replace the version-specific component of a path in the given programming environment on the device or an associated local storage. For example, for a saved package that corresponds to the first programming environment 202 illustrated in FIG. 2A, the device is programmed to create the following three symbolic links in the corresponding established folder identified by “[base path]”:
“[base path]/__SYMLINKS__/python”→“[base path]/lib/python3.6/”
“[base path]/__SYMLINKS__/lib-dynload”→“[base path]/lib/python3.6/lib-dynload”
“[base path]/__SYMLINKS__/site-packages”→“[base path]/lib/python3.6/site-packages”

In some embodiments, the device is programmed to create a symbolic link for each folder where a library can be found in the established folder for each programming environment.

In some embodiments, before launching the programming language interpreter for the new programming environment, the device is programmed to assign priorities to the programming environments to be combined. For example, the device can be programmed to assign the highest priority to the programming environment having files and libraries used by the organizational account associated with the server 102. Doing so helps achieve adherence to organizational standards. The device is programmed to then add the link names of all the symbolic links to an environment variable used to locate libraries for the new programming environment based on the priorities of the programming environments to be combined. For Python, this environment variable is PYTHONPATH. In other examples, such an environment variable can be RUBYLIB for Ruby and PHP_INCLUDE_PATH for PHP. The link names can subsequently be linked to the target paths, namely the pathnames of the sub-folders for the version-specific libraries. During execution, the programming language interpreter generally finds a needed library by traversing the list of paths included in the environment variable in order until some version of the needed library is found. For example, when the first programming environment 202 is prioritized over the second programming environment 204, Python 3.6 will be located first and thus used and Pandas 1.7.5 will be located first and thus used for the new programming environment. Any conflict that might result from such a selection of a specific version can be resolved via user intervention or other means but is otherwise out of the scope of this application. In other embodiments, the device is programmed to skip setting up symbolic links and instead add the pathnames of the sub-folders for the version-specific libraries directly to the environment variable based on the priorities of the programming environments to be combined.

FIG. 2B illustrates aspects of an example combined programming environment. This programming environment corresponds to the combination of the three programming environments illustrated in FIG. 2A. The three programming environments are relocated to this combined programming environment respectively into the first folder 222 at /az/fred1/, the second folder 224 at /az/fred2/, and the third folder 226 at /az/fred3/. Symbolic links are created for each of the three programming environments, as discussed above, where “[base path]” is the path of each of the three folders. As can be seen, the symbolic links point to the sub-folders located in the same folder. The symbolic links are then added to the environment variable PYTHONPATH for the combined programming environment. The device host_4 can be programmed to run a program corresponding to /az/fred1/transforms-python_usercode in the third folder 226, which can rely on various libraries in any of the folders indicated in the environment variable PYTHONPATH for the combined programming environment.

In some embodiments, a device can be tasked to host similar combined programming environments repeatedly. For example, each combined programming environment can comprise the same three types of programming environments illustrated in FIG. 2A. The environment variable can then maintain the same value for different combined programming environments by virtue of the symbolic links, regardless of the specific versions of the programming language used in the programming environments to be combined. For each task, the device can be programmed to request the latest version of a specific programming environment from the server 102 and only retrieve the latest version that is newer than the version already installed locally. For example, it can happen that most of the time, changes occur only in the third type of programming environment with code specific to a user account as that user account works on a specific coding project. Therefore, most of the time, the saved packages for the first two types of programming environments do not need to be retrieved, and locally established folders could be readily combined with a refreshed folder for a new third type of programming environment to form a new combined programming environment. Experimentally, for example, establishing the new combined environment from scratch by retrieving all the relevant files and libraries from the repository might take more than five times as long compared to establishing the new combined environment by combining three programming environments saved as packages in the repository.

### 4. Example Processes

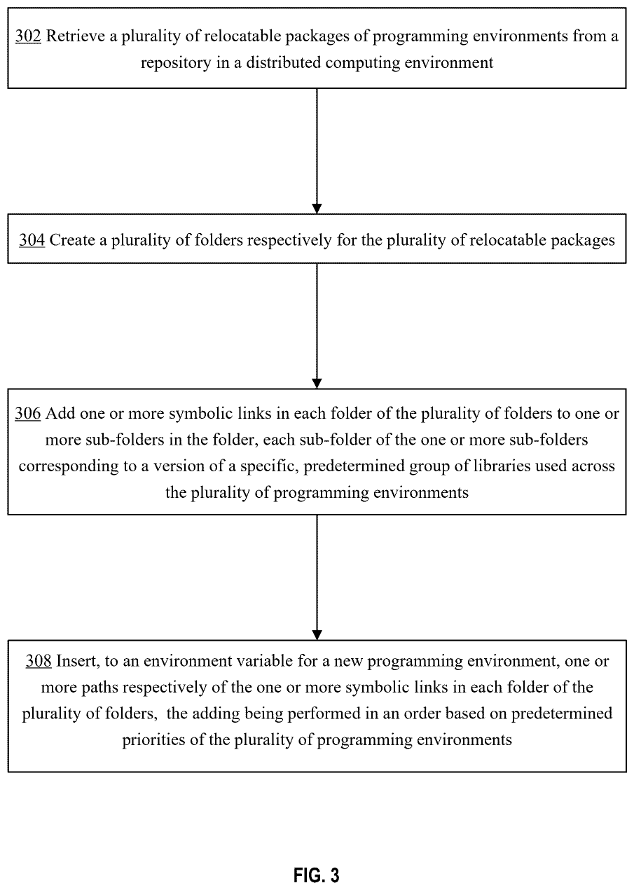

FIG. 3 illustrates a process of creating a new programming environment from existing programming environments in accordance with disclosed embodiments. FIG. 3 is shown in simplified, schematic format for purposes of illustrating a clear example and other embodiments may include more, fewer, or different elements connected in various manners. FIG. 3 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 302, a device is programmed to retrieve a plurality of relocatable packages of programming environments from a repository in a distributed computing environment.

In step 304, the device is programmed to create a plurality of folders respectively for the plurality of relocatable packages. In some embodiments, a relocatable package of the plurality of relocatable packages is a compressed archive, and the creating comprises uncompressing the compressed archive. In other embodiments, the creating further comprises updating a path prefix in at least one file in a folder of the plurality of folders.

In step 306, the device is programmed to add one or more symbolic links in each folder of the plurality of folders to one or more sub-folders in the folder. Each sub-folder of the one or more sub-folders corresponds to a version of a specific, predetermined group of libraries used across the plurality of programming environments.

In some embodiments, the adding further comprises, for a specific symbolic link, identifying a version number of the corresponding specific, predetermined group of libraries, where the specific symbolic link has a path that replaces the version number by a common symbol. In certain embodiments, the one or more symbolic links respectively point to a first group of core libraries, a second group of dynamically loaded libraries, and a third group of third-party extension libraries for a programming language.

In step 308, the device is programmed to insert, to an environment variable for a new programming environment, one or more paths respectively of the one or more symbolic links in each folder of the plurality of folders, where the adding is performed in an order based on predetermined priorities of the plurality of programming environments. In some embodiments, the new programming environment is a Python programming environment.

In some embodiments, the plurality of programming environments includes a first programming environment containing programming dependencies associated with a server or a corresponding organization account, a second programming environment containing programming dependencies associated with a user device or a corresponding user account in the distributed computing environment, and a third programming environment containing programming modules associated the user device or the corresponding user account. In certain embodiments, the first programming environment, the second programming environment, and the third programming environment have decreasing priorities.

In some embodiments, the device is further programmed to receive a request to execute a new command in the new programming environment, and execute the new command in response to the request in the new programming environment.

In some embodiments, the device is further programmed to retrieve a certain relocatable package of a certain programming environment from the repository to replace a first relocatable package of the plurality of relocatable packages. The device is programmed to then reuse the folder for the first relocatable package for the certain relocatable package after removing files from the first relocatable package from the folder. In addition, the device is programmed to update the one or more symbolic links in the folder based on the certain relocatable package. In certain embodiments, the device is further programmed to receive a request to execute a new command in the new programming environment after the certain relocatable package replaces the first relocatable package, and execute the new command in the new programming environment without updating the environment variable.

In some embodiments, the device is further programmed to receiving an update to a specific folder of the plurality of folders. The device is programmed to then create a new relocatable package of a specific programming environment corresponding to the specific folder. In addition, the device is programmed to transmit the new relocatable package to the repository.

### 5. Example Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

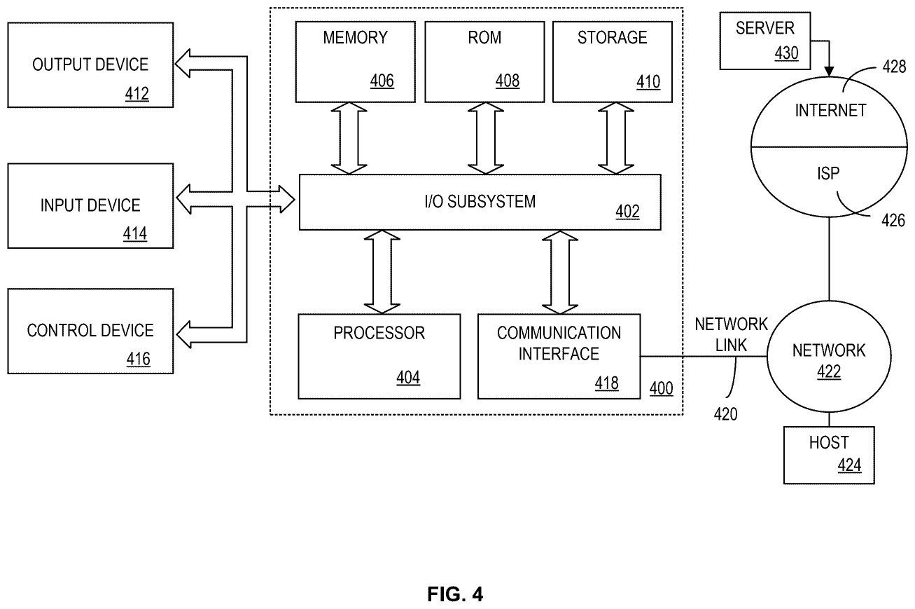

FIG. 4 illustrates an example computer system upon which various embodiments may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as flash memory, or solid-state storage, magnetic disk, or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, XML, Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators, or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on the output device 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to I/O subsystem 402. Communication interface 418 provides a two-way data communication coupling to network link(s) 420 that are directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a LAN, WAN, campus network, internetwork, or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server 430 may be coupled to internet 428. Server 430 broadly represents any computer, data center, virtual machine, or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, Uniform Resource Locator (URL) strings with parameters in HTTP payloads, application programming interface (API) calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using SQL or NoSQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method of creating a new programming environment from existing programming environments, comprising:
retrieving a plurality of relocatable packages of programming environments from a repository in a distributed computing environment;
creating a plurality of folders respectively for the plurality of relocatable packages;
adding one or more symbolic links in each folder of the plurality of folders to one or more sub-folders in the folder,
each sub-folder of the one or more sub-folders corresponding to a version of a specific, predetermined group of libraries used across the plurality of programming environments;
inserting, to an environment variable for a new programming environment, one or more link names respectively of the one or more symbolic links in each folder of the plurality of folders,
the inserting being performed in an order based on predetermined priorities of the plurality of programming environments,
wherein the method is performed by one or more processors.

2. The method of claim 1, further comprising:
receiving a request to execute a new command in the new programming environment;
executing the new command in response to the request in the new programming environment.

3. The method of claim 1,
a relocatable package of the plurality of relocatable packages being a compressed archive,
the creating comprising uncompressing the compressed archive.

4. The method of claim 3, the creating further comprising updating a path prefix in at least one file in a folder of the plurality of folders.

5. The method of claim 1,
the adding further comprising, for a specific symbolic link, identifying a version number of the corresponding specific, predetermined group of libraries,
the specific symbolic link having a link name that replaces the version number by a common symbol.

6. The method of claim 1, the one or more symbolic links respectively pointing to a first group of core libraries, a second group of dynamically loaded libraries, and a third group of third-party extension libraries for a programming language.

7. The method of claim 1, the plurality of programming environments including a first programming environment containing programming dependencies associated with a server or a corresponding organization account, a second programming environment containing programming dependencies associated with a user device or a corresponding user account in the distributed computing environment, and a third programming environment containing programming modules associated the user device or the corresponding user account.

8. The method of claim 7, the first programming environment, the second programming environment, and the third programming environment having decreasing priorities.

9. The method of claim 1, further comprising:
retrieving a certain relocatable package of a certain programming environment from the repository to replace a first relocatable package of the plurality of relocatable packages;
reusing the folder for the first relocatable package for the certain relocatable package after removing files from the first relocatable package from the folder;
updating the one or more symbolic links in the folder based on the certain relocatable package.

10. The method of claim 9, further comprising:
receiving a request to execute a new command in the new programming environment after the certain relocatable package replaces the first relocatable package;
executing the new command in the new programming environment without updating the environment variable.

11. The method of claim 1, further comprising:
receiving an update to a specific folder of the plurality of folders;
creating a new relocatable package of a specific programming environment corresponding to the specific folder;
transmitting the new relocatable package to the repository.

12. The method of claim 1, the new programming environment being a Python programming environment.

13. A computer system for creating a new programming environment from existing programming environments, comprising:
a memory;
one or more processors coupled to the memory and configured to perform:
retrieving a plurality of relocatable packages of programming environments from a repository in a distributed computing environment;
creating a plurality of folders respectively for the plurality of relocatable packages;
adding one or more symbolic links in each folder of the plurality of folders to one or more sub-folders in the folder,
each sub-folder of the one or more sub-folders corresponding to a version of a specific, predetermined group of libraries used across the plurality of programming environments;
inserting, to an environment variable for a new programming environment, one or more link names respectively of the one or more symbolic links in each folder of the plurality of folders,
the inserting being performed in an order based on predetermined priorities of the plurality of programming environments.

14. The system of claim 13,
the adding further comprising, for a specific symbolic link, identifying a version number of the corresponding specific, predetermined group of libraries,
the specific symbolic link having a path that replaces the version number by a common symbol.

15. The system of claim 13, the one or more symbolic links respectively pointing to a first group of core libraries, a second group of dynamically loaded libraries, and a third group of third-party extension libraries for a programming language.

16. The system of claim 13, the plurality of programming environments including a first programming environment containing programming dependencies associated with a server or a corresponding organization account, a second programming environment containing programming dependencies associated with a user device or a corresponding user account in the distributed computing environment, and a third programming environment containing programming modules associated the user device or the corresponding user account.

17. The system of claim 16, the first programming environment, the second programming environment, and the third programming environment having decreasing priorities.

18. The system of claim 13, the one or more processors configured to further perform:
retrieving a certain relocatable package of a certain programming environment from the repository to replace a first relocatable package of the plurality of relocatable packages;
reusing the folder for the first relocatable package for the certain relocatable package after removing files from the first relocatable package from the folder;
updating the one or more symbolic links in the folder based on the certain relocatable package.

19. The system of claim 18, the one or more processors configured to further perform:
receiving a request to execute a new command in the new programming environment after the certain relocatable package replaces the first relocatable package;
executing the new command in the new programming environment without updating the environment variable.

20. One or more non-transitory storage media storing instructions which when executed cause one or more processors to perform:
retrieving a plurality of relocatable packages of programming environments from a repository in a distributed computing environment;
creating a plurality of folders respectively for the plurality of relocatable packages;
adding one or more symbolic links in each folder of the plurality of folders to one or more sub-folders in the folder,
each sub-folder of the one or more sub-folders corresponding to a version of a specific, predetermined group of libraries used across the plurality of programming environments;
inserting, to an environment variable for a new programming environment, one or more link names respectively of the one or more symbolic links in each folder of the plurality of folders,
the inserting being performed in an order based on predetermined priorities of the plurality of programming environments.
